(19) United States
(12) Patent Application Publication
(10) Pub. No.: US 2025/0180043 A1
(43) Pub. Date: Jun. 5, 2025

(54) FLUID PRESSURE CIRCUIT

(71) Applicant: EAGLE INDUSTRY CO., LTD., Tokyo (JP)

(72) Inventor: Yoshiyuki SHIMADA, Tokyo (JP)

(21) Appl. No.: 18/841,655

(22) PCT Filed: Feb. 17, 2023
(86) PCT No.: PCT/JP2023/005748

§ 371 Date: Aug. 26, 2024

(30) Foreign Application Priority Data
Feb. 28, 2022 (JP) 2022-029996

(51) Int. Cl. F15B 21/14; F15B 11/024; F15B 11/044

(52) U.S. Cl. CPC F15B 21/14; F15B 11/024; F15B 11/044; F15B 2011/0243; F15B 2211/40515; F15B 2211/46

(57) ABSTRACT

There is provided a fluid pressure circuit capable of saving energy. A fluid pressure circuit includes: a fluid supply source; a cylinder device; a valve that diverts some of a return fluid from the cylinder device to discharge the return fluid via a throttle; and a recovery passage R1 which is provided between the fluid supply source and the cylinder device and through which the return fluid flows from a first chamber of the cylinder device to a second chamber of the cylinder device.

### TECHNICAL FIELD

The present invention relates to a fluid pressure circuit, for example, a fluid pressure circuit used to control the operation of a cylinder device.

### BACKGROUND ART

A fluid pressure circuit is used to control operation of a cylinder device in an automobile, a construction machine, a cargo handling vehicle, an industrial machine, and the like. For example, a hydraulic excavator supplies a pressure fluid from a hydraulic pump to a cylinder device connected to a hydraulic circuit as the fluid pressure circuit, to extend and retract the cylinder device to drive a load. In such a fluid pressure circuit, energy saving is required, and some of the fluid discharged from the cylinder device may be regenerated by a regenerative motor to effectively utilize energy.

An example of such a fluid pressure circuit is disclosed in Patent Citation 1. A fluid pressure circuit of Patent Citation 1 mainly includes a pump; a cylinder device; a regenerative motor; a switching valve connected between the pump and the cylinder device; and a flow diverter valve capable of diverting a fluid discharged from the cylinder device to the regenerative motor. The switching valve is configured such that a spool can be changed to an extension position, a neutral position, or a retraction position. The flow diverter valve is configured such that a spool is changed from a neutral position to a flow diversion position.

Accordingly, when the switching valve is switched to the extension position, pressure oil from the hydraulic pump is introduced into a bottom chamber of the cylinder device, and a rod extends from a cylinder. On the other hand, when the switching valve is switched to the retraction position, the pressure oil from the hydraulic pump is introduced into a rod chamber of the cylinder device, and the rod retracts into the cylinder.

### CITATION LIST

### Patent Literature

Patent Citation 1: WO 2018/147261 A (Page 7, FIG. 2)

### SUMMARY OF INVENTION

### Technical Problem

In the fluid pressure circuit as in Patent Citation 1, when the rod retracts, the spool of the flow diverter valve is moved from the neutral position to the flow diversion position, and some of the return oil discharged from the bottom chamber is supplied to the regenerative motor to drive a generator, thereby being able to obtain electric energy.

By the way, particularly in recent years, awareness of energy saving has been increasing from the viewpoint of SDGs, carbon neutrality, and the like. Therefore, it is desirable that a regenerative drive device such as a generator that uses the fluid discharged as the cylinder device extends and retracts, as a drive source, and a recovery passage for reusing the fluid discharged as the cylinder device extends and retracts, as a fluid supplied to the cylinder device, are used together. However, when the regenerative drive device and the recovery passage are attempted to be used together, both regeneration and recovery cannot be stably operated, such as not being able to obtain sufficient fluid pressure that allows the fluid to pass through the recovery passage and to flow into a flow passage on a supply side.

The present invention has been made in view of such problems, and an object of the present invention is to provide a fluid pressure circuit capable of saving energy.

### Solution to Problem

In order to solve the foregoing problems, a fluid pressure circuit according to the present invention is a fluid pressure circuit including: a fluid supply source; a cylinder device including a first chamber and a second chamber which are partitioned from each other; a valve that diverts some of a return fluid from the cylinder device to discharge the return fluid via a throttle; and a recovery passage which is provided between the fluid supply source and the cylinder device and through which the return fluid flows from the first chamber to the second chamber. According to the aforesaid features of the present invention, since some of the return fluid from the cylinder device is discharged via the throttle, the pressure of the fluid on a primary side of a cylinder device side can be stabilized. Accordingly, the fluid at appropriate pressure is allowed to flow into a recovery passage side. For that reason, an energy-saving circuit can be achieved.

It may be preferable that the fluid pressure circuit further includes, in addition to a throttle passage provided with the throttle in the valve, a low-fluid-resistance passage with a lower fluid resistance than the throttle passage, and the low-fluid-resistance passage is configured for communicating with the recovery passage. According to this preferable configuration, a decrease in the operation speed of the cylinder device can be suppressed, and the recovery efficiency can be increased.

It may be preferable that the low-fluid-resistance passage is provided in the valve. According to this preferable configuration, the fluid pressure circuit can be simplified.

It may be preferable that the throttle passage includes two passage parts, and one of the two passage parts is configured for communicating with the recovery passage. According to this preferable configuration, the fluid can be guided to the low-fluid-resistance passage with priority. In addition, a decrease in the operation speed of the cylinder device can be more effectively suppressed.

It may be preferable that the fluid pressure circuit further includes a switching valve provided in a flow passage between the fluid supply source and the valve to control an inflow and outflow of a fluid between the fluid supply source and the cylinder device, and the recovery passage is provided inside the switching valve. According to this preferable configuration, the position controls of the valve and the switching valve can be synchronized, and the fluid used for recovery is efficiently supplied to the cylinder device side.

It may be preferable that the recovery passage is configured to allow for a flow therein only when the cylinder device is retracted. According to this preferable configuration, by using the gravity acting on the cylinder device, the pressure of the fluid on the primary side of the cylinder device side which is higher than the pressure of the fluid pressure-fed from the fluid supply source can be more reliably ensured.

### BRIEF DESCRIPTION OF DRAWINGS

FIG. 1 is a view illustrating a wheel loader into which a hydraulic circuit as a fluid pressure circuit according to a first embodiment of the present invention is built.

FIG. 2 is a view illustrating the hydraulic circuit in the first embodiment.

FIG. 3 is a graph illustrating a relationship between an operation lever stroke and a pilot secondary pressure in the first embodiment.

FIG. 4 is a graph illustrating a relationship between a spool stroke and an opening area when a switching valve is retracted in the first embodiment.

FIG. 5 is a graph illustrating a relationship between the operation lever stroke and the retraction speed of a rod of a cylinder device in the first embodiment.

FIG. 6 is a graph illustrating a relationship between an electric signal from a controller and a priority flow rate of a flow diverter valve in the first embodiment.

FIG. 7 is a graph illustrating a relationship between the rotation speed and the output electric power of a regenerative mechanism in the first embodiment.

FIG. 8 is an enlarged view of main parts illustrating a flow diverter valve device at a neutral position and the switching valve in the first embodiment.

FIG. 9 is an enlarged view of main parts illustrating the flow diverter valve device at an actuation position and the switching valve in the first embodiment.

FIG. 10 is a view illustrating a hydraulic circuit as a fluid pressure circuit according to a second embodiment of the present invention.

FIG. 11 is a graph illustrating a relationship between an electric signal from the controller and an opening area of a recovery valve in the second embodiment.

FIG. 12 is an enlarged view of main parts illustrating a flow diverter valve device at the neutral position, a recovery valve, and a switching valve in the second embodiment.

FIG. 13 is an enlarged view of main parts illustrating the flow diverter valve device at the actuation position, the recovery valve, and the switching valve in the second embodiment.

FIG. 14 is a view illustrating a hydraulic circuit as a fluid pressure circuit according to a third embodiment of the present invention.

FIG. 15 is a perspective view, a plan view, and a side view illustrating a switching valve and a flow diverter valve device in the third embodiment.

FIG. 16 is an enlarged view of main parts illustrating the flow diverter valve device at the neutral position and the switching valve in the third embodiment.

FIG. 17 is an enlarged view of main parts illustrating the flow diverter valve device at the actuation position and the switching valve in the third embodiment.

FIG. 18 is a graph illustrated to compare a retraction speed of a rod with respect to an operation lever stroke during flow diversion in the third embodiment.

FIG. 19 is a view illustrating another flow diverter valve that can be applied as the flow diverter valve in the third embodiment.

FIG. 20 is a graph illustrating a relationship between an electric signal from the controller and a priority flow rate of yet another flow diverter valve that can be applied as the flow diverter valve in the third embodiment.

FIG. 21 is a view illustrating a hydraulic circuit as a fluid pressure circuit according to a fourth embodiment of the present invention.

### DESCRIPTION OF EMBODIMENTS

Modes for implementing a fluid pressure circuit according to the present invention will be described below based on embodiments.

### First Embodiment

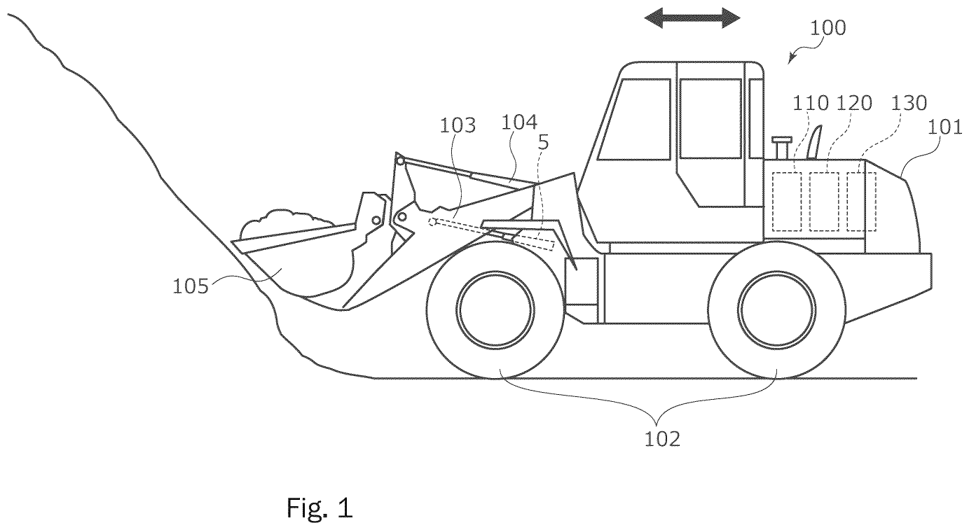

A fluid pressure circuit according to a first embodiment of the present invention will be described with reference to FIGS. 1 to 9.

A hydraulic circuit as the fluid pressure circuit according to the first embodiment is a hydraulic circuit that controls the stroke of a cylinder device in response to an operation command in a work machine, a construction machine, a cargo handling vehicle, an automobile, or the like, and is built into, for example, the powertrain of a wheel loader 100 illustrated in FIG. 1. The wheel loader 100 mainly includes a vehicle body 101, wheels 102 for traveling, a work arm 103, a hydraulic cylinder 104, and a bucket 105 for taking gravel or the like. The vehicle body 101 is provided with a machine 110 such as an engine, a fluid circuit 120 for traveling, the hydraulic cylinder 104, and a hydraulic circuit 130 for work that drives a hydraulic cylinder 5 as a cylinder device and the like.

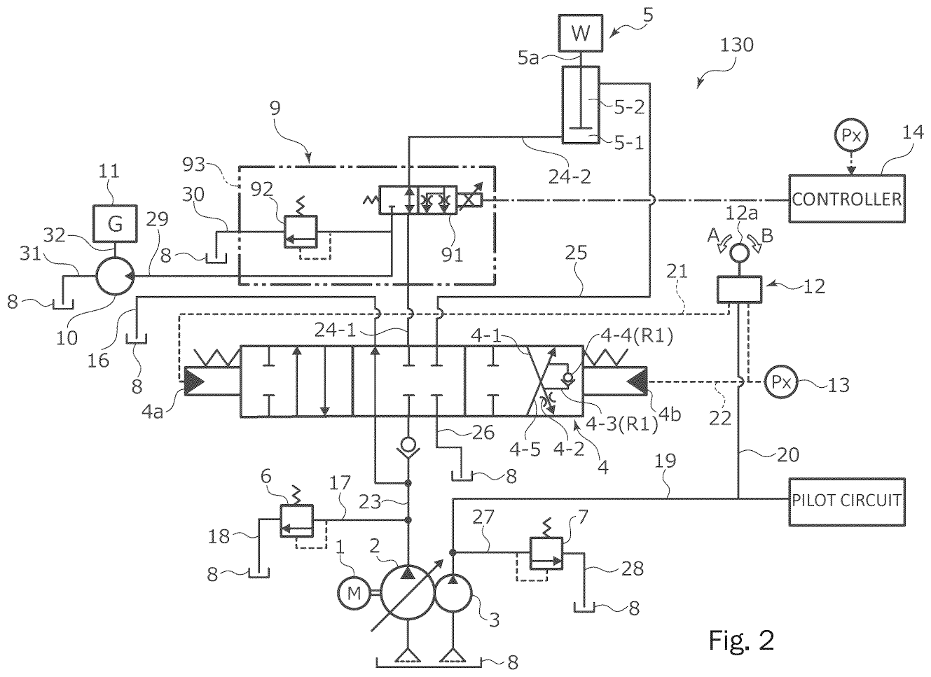

As illustrated in FIG. 2, the hydraulic circuit 130 includes a main hydraulic pump 2 as fluid supply means driven by a drive mechanism 1 such as an engine or an electric motor; a pilot hydraulic pump 3; a switching valve 4; the hydraulic cylinder 5; a relief valve 6; a relief valve 7; a tank 8; a flow diverter valve device 9; a regenerative motor 10 and a generator 11 as a regenerative mechanism; a remote control valve 12; a pressure sensor 13; a controller 14; and oil passages 16 to 31. Incidentally, the regenerative motor is provided as an example of a regenerative drive source; however, the regenerative drive source is not limited thereto.

The main hydraulic pump 2 is coupled to the drive mechanism 1 such as an internal combustion engine, and is driven by power from the drive mechanism 1 to supply pressure oil to a downstream side through the oil passage 23.

The pressure oil discharged from the main hydraulic pump 2 flows into the switching valve 4 through the oil passage 23. The switching valve 4 is a 6-port, 3-position open center switching valve, and in a state where a spool is at a neutral position, the entire amount of pressure oil discharged from the main hydraulic pump 2 flows to the tank 8 through the oil passage 16.

In addition, in a main circuit including the main hydraulic pump 2, in order to prevent oil devices in the circuit from being damaged due to the pressure of the oil in the circuit becoming abnormally high when a rod 5a of the hydraulic cylinder 5 has reached an extension termination or a retraction termination or a sudden load is applied to the hydraulic cylinder 5, the relief valve 6 is installed, and the high-pressure oil is discharged into the tank 8 through the oil passage 17 and the oil passage 18.

Next, similarly to the main hydraulic pump 2, the pilot hydraulic pump 3 is coupled to the drive mechanism 1 and is driven by power from the drive mechanism 1 to supply the pressure oil to a downstream side through the oil passage 19. Here, some of the pressure oil supplied to the downstream side through the oil passage 19 is supplied to the remote control valve 12 through the oil passage 20.

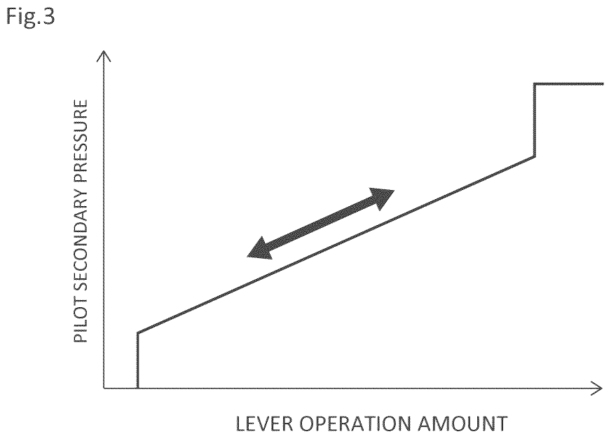

The remote control valve 12 is a variable pressure-reducing valve, and controls the extension position (extension amount) or retraction position (retraction amount) of the rod 5a by supplying a pilot secondary pressure, which is proportional to the operation lever stroke of an operation lever 12a as illustrated in FIG. 3, to a signal port 4a or a signal port 4b of the switching valve 4 through the pilot signal oil passage 21 or the pilot signal oil passage 22 through operating the rod 5a of the hydraulic cylinder 5 in an extension direction A or a retraction direction B using the operation lever 12a. Incidentally, an operation amount of the operation lever 12a is substantially equivalent to a stroke of the operation lever 12a, and is referred to as an operation lever stroke.

When the operation lever 12a of the remote control valve 12 is operated in the extension direction A and the switching valve 4 is switched to an extension position, the pressure oil from the main hydraulic pump 2 flows into a bottom chamber 5-1 of the hydraulic cylinder 5 through the oil passage 23, the oil passage 24-1, the flow diverter valve device 9, and the oil passage 24-2, and the oil in a rod chamber 5-2 passes through the oil passage 25, and is discharged into the tank 8 further through the oil passage 26 via the switching valve 4. Accordingly, the rod 5a of the hydraulic cylinder 5 actuates in the extension direction.

On the other hand, when the operation lever 12a of the remote control valve 12 is operated in the retraction direction B and the switching valve 4 is switched to a retraction position, the pressure oil from the main hydraulic pump 2 flows into the rod chamber 5-2 of the hydraulic cylinder 5 through the oil passage 23 and the oil passage 25, and the oil in the bottom chamber 5-1 passes through the oil passage 24-2, the flow diverter valve device 9, and the oil passage 24-1, and is discharged into the tank 8 further through the oil passage 26 via the switching valve 4. Accordingly, the rod 5a of the hydraulic cylinder 5 actuates in the retraction direction.

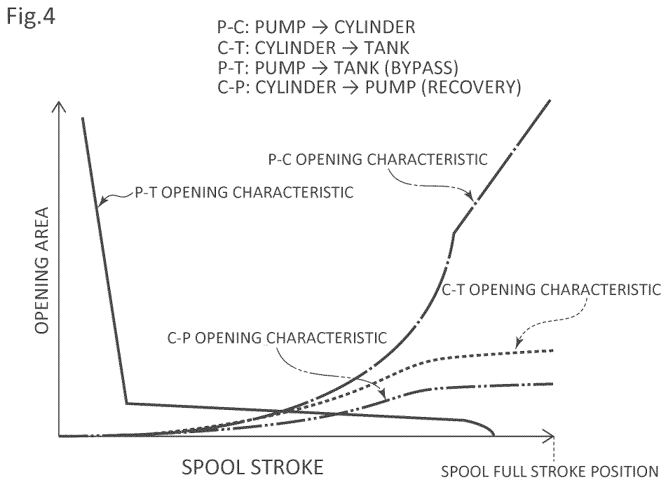

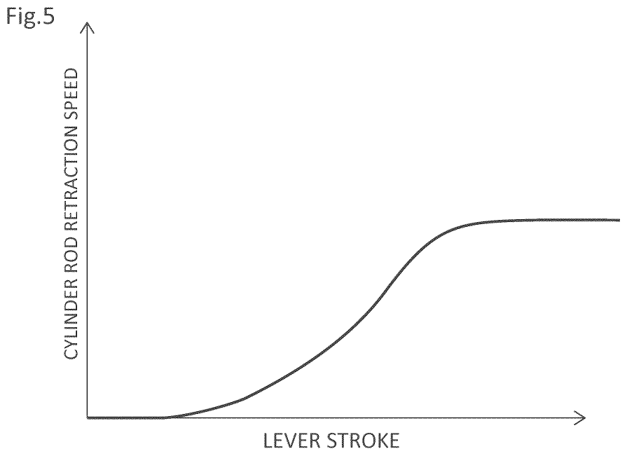

As illustrated in FIG. 3, the remote control valve 12 outputs a pilot secondary pressure that increases proportionally with an increase in the operation lever stroke of the operation lever 12a of the remote control valve 12. The switching valve 4 is configured such that the spool strokes substantially in proportion to the pilot secondary pressure of the remote control valve 12. As illustrated in FIG. 4, since the switching valve 4 has an opening characteristic in which the opening amount thereof increases according to the spool stroke, the oil amount of the pressure oil supplied to the hydraulic cylinder 5 increases with an increase in the opening amount, and as illustrated in FIG. 5, the actuation speed of the rod 5a of the hydraulic cylinder 5 increases. Namely, the rod speed can be controlled according to the operation lever stroke of the operation lever 12a of the remote control valve 12.

In addition, when a weight W acts on the hydraulic cylinder 5 in the direction of gravity as illustrated in FIG. 2, the rod speed is predominantly controlled by a C-T opening (cylinder→tank) of FIG. 4.

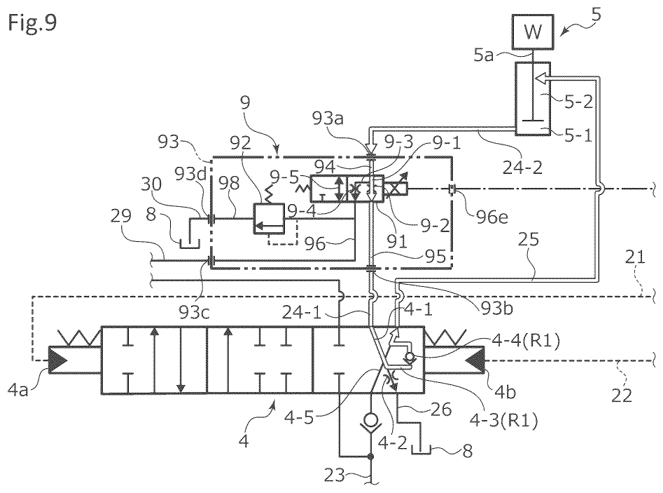

Returning to FIG. 2, the switching valve 4 has an oil passage 4-1, a throttle 4-2, an oil passage 4-3, a check valve 4-4, and an oil passage 4-5 on a retraction position side. At a retraction position, the oil passage 4-1 is connected to the oil passage 24-1 and the oil passage 26 (refer to FIG. 9). The throttle 4-2 is provided in the oil passage 4-1. The oil passage 4-3 is diverted and connected to the oil passage 4-1 on a hydraulic cylinder 5 side with respect to the throttle 4-2, and is diverted and connected to the oil passage 4-5. The check valve 4-4 is provided in the oil passage 4-3. The oil passage 4-5 is connected to the oil passage 23 and the oil passage 25 (refer to FIG. 9).

In the oil passage 4-1, the flow rate of the return oil discharged from the bottom chamber 5-1 of the hydraulic cylinder 5 to flow toward the tank 8 is throttled by the throttle 4-2. Accordingly, the pressure of the return oil discharged from the bottom chamber 5-1 is easily maintained in a region of the oil passage 4-1 on the hydraulic cylinder 5 side with respect to the throttle 4-2.

Since the return oil discharged from the bottom chamber 5-1 is increased in pressure by the weight W acting in the direction of gravity in addition to the fluid pressure of the oil that has flowed into the rod chamber 5-2, the pressure of the return oil easily becomes higher than a fluid pressure of the oil that is pressure-fed by the main hydraulic pump 2 to flow through the oil passage 4-5.

For that reason, as illustrated in FIG. 9, when the fluid pressure in the region of the oil passage 4-1 on the hydraulic cylinder 5 side with respect to the throttle 4-2 is higher than the fluid pressure in the oil passage 4-5, the check valve 4-4 is opened.

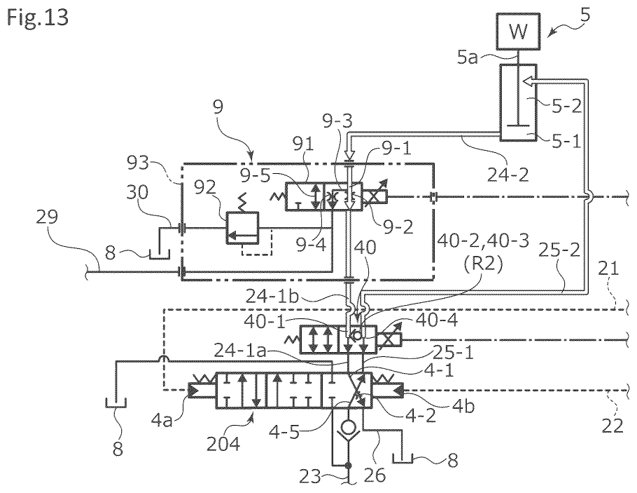

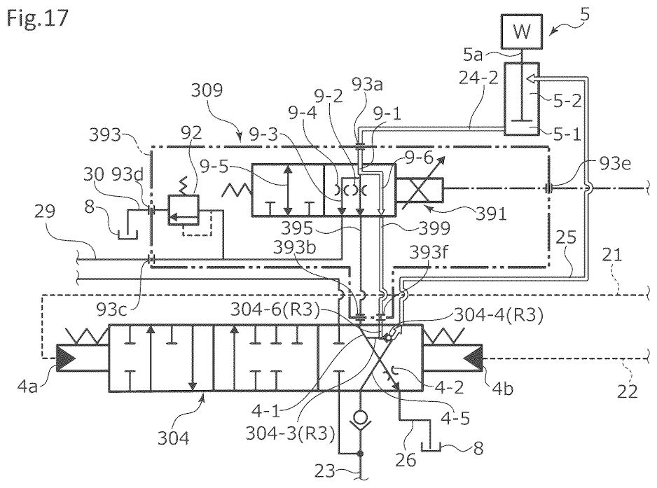

Accordingly, as indicated by white arrows in FIG. 9, the oil discharged from the bottom chamber 5-1 of the hydraulic cylinder 5 flows into the oil passage 4-5 through the oil passages 4-1 and 4-3 and the check valve 4-4, and is supplied to the rod chamber 5-2 together with the oil pressure-fed by the main hydraulic pump 2. Incidentally, the white arrows in FIG. 9 are for indicating a recovery flow direction, and the reflection of pressure or flow rate is omitted. This also applies to FIGS. 13 and 17.

In such a manner, since the high-pressure oil discharged from the bottom chamber 5-1 of the hydraulic cylinder 5 can be reused to actuate the rod 5a of the hydraulic cylinder 5 in the retraction direction, the load on the main hydraulic pump 2 can be reduced to achieve energy saving. Here, the oil passage 4-3 and the check valve 4-4 are a recovery passage R1 in the present invention.

As illustrated in FIG. 2, in a pilot circuit including the pilot hydraulic pump 3, the relief valve 7 is installed to control a maximum pressure in the circuit, and when the lever of the remote control valve 12 is in neutral, the pressure oil is discharged into the tank 8 through the oil passage 27 and the oil passage 28.

The flow diverter valve device 9 is provided between the oil passage 24-1 and the oil passage 24-2 that connect the bottom chamber 5-1 of the hydraulic cylinder 5 and the switching valve 4.

The flow diverter valve device 9 mainly includes a flow diverter valve 91 that is a 3-port, 2-position normally open electromagnetic proportional throttle valve; a relief valve 92 that controls a maximum pressure in the circuit of the flow diverter valve device 9; and a housing 93 that accommodates the flow diverter valve 91 and the relief valve 92.

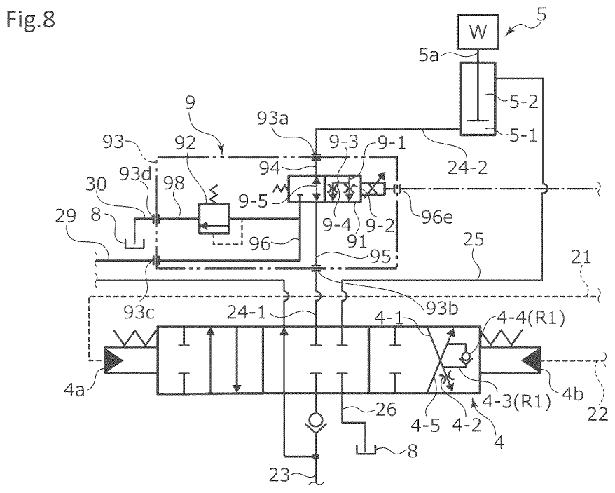

As illustrated in FIGS. 8 and 9, the housing 93 is provided with ports 93a to 93d, an opening 96e, and oil passages 94 to 98.

The port 93a communicates with the oil passage 24-2. The port 93b communicates with the oil passage 24-1. The port 93c communicates with the oil passage 29 extending from the regenerative motor 10. The port 93d communicates with the oil passage 30 communicating with the tank 8. An electric signal line connecting the controller 14 and the flow diverter valve 91 is inserted into the opening 93e that is a through-hole.

The oil passage 94 connects the port 93a and the flow diverter valve 91. The oil passage 95 connects the flow diverter valve 91 and the port 93b. The oil passage 96 connects the flow diverter valve 91 and the port 93c. The oil passage 97 connects the oil passage 96 and the relief valve 92. The oil passage 98 connects the relief valve 92 and the port 93d.

The flow diverter valve 91 is a pressure-compensated electromagnetic proportional control type flow rate adjustment valve capable of variably diverting a flow rate (hereinafter, may also be referred to as a priority flow rate) to an oil passage 9-3 side to be described later in response to an electric signal from the controller 14.

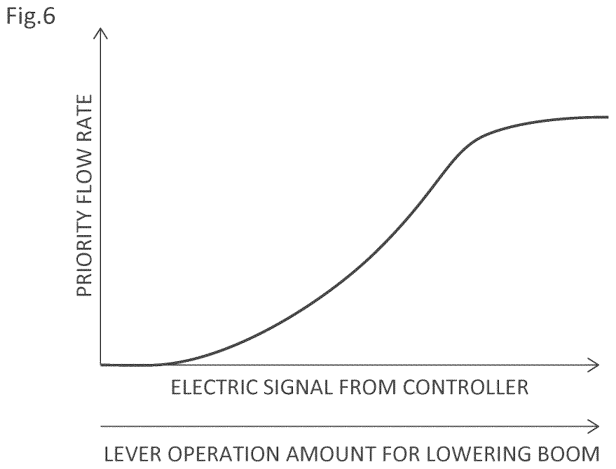

Incidentally, the flow diverter valve 91 has a flow rate control characteristic as illustrated in FIG. 6. When no electric signal is input from the controller 14, the priority flow rate to the oil passage 9-3 side is zero, and the priority flow rate can increase or decrease in proportion to an electric signal from the controller 14.

The flow diverter valve 91 includes an oil passage 9-1, a throttle 9-2, the oil passage 9-3, a throttle 9-4, and an oil passage 9-5. The throttle 9-2 is provided in the oil passage 9-1 on a switching valve 4 side with respect to a location where the oil passage 9-3 is diverted and connected to the oil passage 9-1. The oil passage 9-3 is diverted and connected to the oil passage 9-1, and is connected to the oil passage 29. The throttle 9-4 is provided in the oil passage 9-3.

The oil passage 9-1 is connected to the oil passage 24-1 and the oil passage 24-2 as a function of a position to which the flow diverter valve 91 is switched from a neutral position, namely, a regeneration position. The oil passage 9-5 is connected to the oil passage 24-1 and the oil passage 24-2 as a function of the neutral position, namely, a non-regeneration position.

In addition, in the flow diverter valve device 9, the relief valve 92 is installed between the oil passages 97 and 98 to prevent oil devices inside the flow diverter valve device 9 from being damaged due to the pressure of the oil in the oil passages becoming abnormally high, and the high-pressure oil is discharged into the tank 8 through the oil passages 97 and 98 and the oil passage 30.

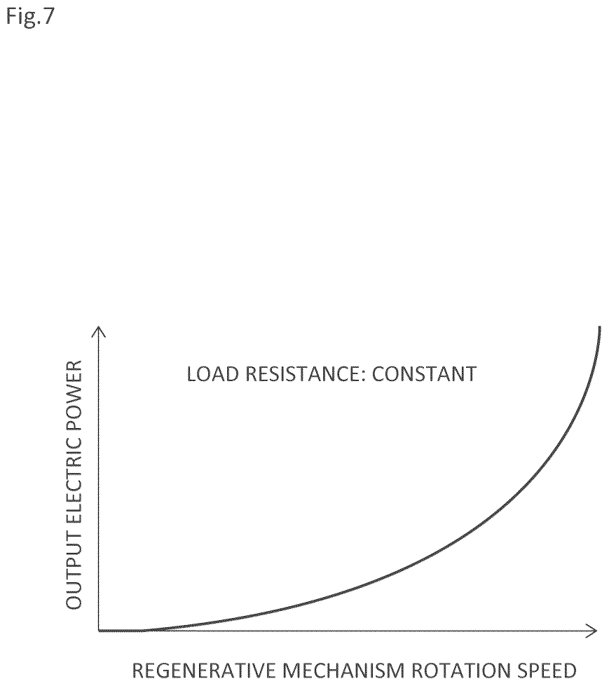

The generator 11 is coupled to the regenerative motor 10 by a coupling portion 32, and outputs electric power with an output characteristic as illustrated in FIG. 7 according to the rotation speed of a drive mechanism such as the regenerative motor 10. In addition, when the amount of electricity generated by the generator 11 has reached an allowable electricity storage amount of an electricity storage device, the electric signal from the controller 14 to the flow diverter valve 91 is cut off, and the flow diverter valve 91 returns to the neutral position, so that the flow of the oil into the regenerative motor 10 is cut off, and the generator 11 is stopped not to generate electricity.

Next, regeneration and recovery using the return oil in the hydraulic circuit 130 will be described.

As illustrated in FIG. 2, the pressure sensor 13 is installed on the pilot signal oil passage 22, and when the operation lever 12a of the remote control valve 12 is operated in the retraction direction B and the pilot secondary pressure occurs in the pilot signal oil passage 22, an electric signal is input to the controller 14 from the pressure sensor 13.

When an electric signal is input to the controller 14 and the electricity storage device (not illustrated) has reached the allowable electricity storage amount, an electric signal is not output to the flow diverter valve 91 from an arithmetic circuit built into the controller 14 in advance. Accordingly, the flow diverter valve 91 remains in the non-regeneration position.

Accordingly, in a state where the flow diverter valve 91 is at the non-regeneration position, the entire amount of return oil discharged from the inside of the bottom chamber 5-1 of the hydraulic cylinder 5 passes through the oil passage 24-2, the oil passage 94, the oil passage 9-5 of the flow diverter valve 91, the oil passage 95, and the oil passage 24-1, and further flows into the oil passage 4-1 of the switching valve 4.

Then, a fluid pressure Pr of the return oil on an oil passage 4-1 side with respect to the check valve 4-4 of the switching valve 4 is higher than a fluid pressure Pf of the outgoing oil pressure-fed by the main hydraulic pump 2 on an oil passage 4-5 side with respect to the check valve 4-4 (Pr>Pf), the check valve 4-4 is opened, and as indicated by the white arrows in FIG. 9, the return oil is reused as outgoing oil. In addition, some of the return oil that has flowed into the oil passage 4-1 passes through the throttle 4-2 and the oil passage 26, and is discharged into the tank 8.

On the other hand, when an electric signal is input to the controller 14 and the electricity storage device has not reached the allowable electricity storage amount, an electric signal is output from the arithmetic circuit in the controller 14 to the flow diverter valve 91. Accordingly, the flow diverter valve 91 is switched to the regeneration position. In relation to this, the controller 14 controls the flow diverter valve 91 to be switched at the same time that the switching valve 4 is switched.

The flow diverter valve 91 switched from the neutral position to the regeneration position throttles the flow rate of the return oil, which has flowed into the oil passage 9-3, using the throttle 9-4, and causes the return oil to flow into the oil passage 29. At this time, by throttling the flow rate using the throttle 9-4, in other words, by obstructing the flow of the return oil, the remaining return oil is allowed to pass through the oil passage 9-1 while maintaining a suitable primary pressure.

In addition, since the throttle 9-2 is also provided in the oil passage 9-1, some of the return oil can be guided to the oil passage 9-3. Namely, the flow diverter valve 91 can reliably divert the return oil to the oil passage 24-1 and the oil passage 29.

For that reason, in the hydraulic circuit 130, some of the return oil flows into the regenerative motor 10 through the oil passage 29 via the flow diverter valve 91, so that the regenerative motor 10 rotates and electricity is generated by the generator 11. The return oil that has passed through the regenerative motor 10 is discharged into the tank 8 via the oil passage 31.

In addition, the opening degree of the throttle 9-2 and the opening degree of the throttle 9-4 are adjusted such that the fluid pressure of the return oil flowing into the oil passage 24-1 becomes higher than the fluid pressure of the oil pressure-fed by the main hydraulic pump 2.

Accordingly, even in a state where the flow diverter valve 91 is at the regeneration position, since the check valve 4-4 is opened according to a differential pressure ΔP between the fluid pressure Pr of the return oil on the oil passage 4-1 side with respect to the check valve 4-4 of the switching valve 4 and the fluid pressure Pf of the outgoing oil on the oil passage 4-5 side with respect to the check valve 4-4, as indicated by the white arrows in FIG. 9, the return oil can be reused as outgoing oil.

As described above, in the hydraulic circuit 130 of the present embodiment, some of the return oil from the hydraulic cylinder 5 via the throttle 9-4 of the flow diverter valve 91 drives the regenerative motor 10, and then is discharged into the tank 8. For that reason, the pressure of the oil on a primary side of the hydraulic cylinder 5 side, namely, the pressure of the oil passing through the oil passages 24-2, 9-1, and 24-1 can be stabilized. Accordingly, the oil at appropriate pressure is allowed to flow into the oil passage 4-3 and a check valve 4-4 side. For that reason, an energy-saving circuit can be achieved.

In addition, the switching valve 4 is disposed close to the flow diverter valve 91, in other words, only via the oil passage 24-1. For that reason, by synchronizing the timing of switching the flow diverter valve 91 from the non-regeneration position to the regeneration position and the timing of switching the switching valve 4 from the neutral position to the retraction position, the return oil is allowed to smoothly flow into the oil passage 9-1 of the flow diverter valve 91, the oil passage 24-1, and the oil passage 4-1 of the switching valve 4 from the oil passage 24-2, and the return oil is also allowed to smoothly flow into the oil passage 9-3 of the flow diverter valve 91 and the oil passage 29 from the oil passage 24-2. In such a manner, in diverting the return oil flowing through the oil passage 24-2, controlling the timing of switching the flow diverter valve 91 and the timing of switching the switching valve 4 is facilitated.

In addition, the recovery passage R1 in the present embodiment is provided in the switching valve 4, and some of the return oil that has flowed into the oil passage 4-1 directly flows into the oil passage 4-3. Accordingly, the influence of flow passage resistance and the like acting on the return oil can be reduced compared to a case where the recovery passage is provided separately from the switching valve (for example, a case to be described in a second embodiment to be described later). For that reason, the return oil used for recovery is efficiently supplied to the hydraulic cylinder 5 side. Further, synchronization control is facilitated compared to a case where the switching valve, the flow diverter valve, and the recovery passage are individually synchronized.

In addition, since the recovery passage R1 of the present embodiment is provided on a retraction position side of the switching valve 4, by using the gravity acting on the hydraulic cylinder 5, the pressure of the fluid on the primary side of the hydraulic cylinder 5 side can be more reliably ensured.

Incidentally, the flow diverter valve 91 has been described as being configured such that the throttles 9-2 and 9-4 are provided in the oil passages 9-1 and 9-3; however, the present invention is not limited thereto, and no throttle may be provided in the oil passage 9-1. Even with such a configuration, the priority flow rate passing through the oil passage 9-3 and the throttle 9-4 can be ensured by the throttle 4-2 or the check valve 4-4 of the switching valve 4.

### Second Embodiment

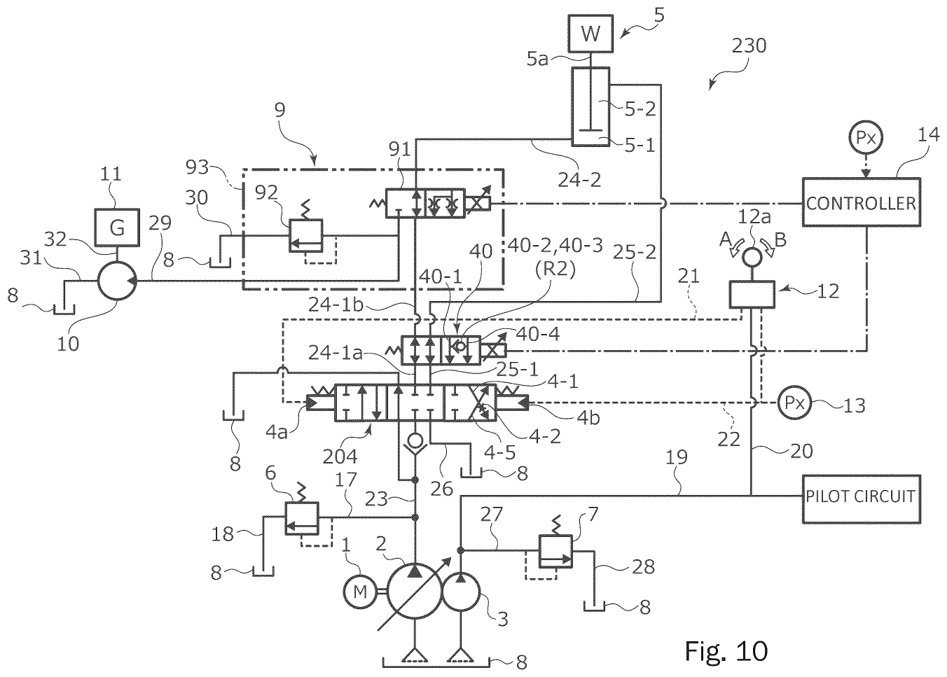

Next, a fluid pressure circuit according to the second embodiment of the present invention will be described with reference to FIGS. 10 to 13. Incidentally, the description of configurations that are the same as and overlap with the configurations of the first embodiment will be omitted.

As illustrated in FIG. 10, a hydraulic circuit 230 in the second embodiment differs from that in the first embodiment in that a switching valve 204 is not provided with a recovery passage and a recovery valve 40 is provided between the switching valve 204 and the flow diverter valve device 9, and has the same configuration in other respects.

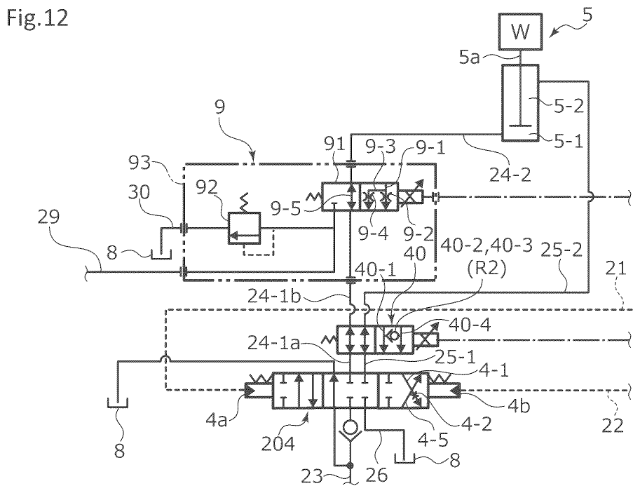

As illustrated in FIGS. 12 and 13, the recovery valve 40 is a 4-port, 2-position electromagnetic proportional valve, and is a flow rate control valve capable of variably controlling the flow rate in response to an electric signal from the controller 14. The recovery valve 40 includes an oil passage 40-1, an oil passage 40-2, a check valve 40-3, and an oil passage 40-4 on a recovery position side where the return oil can be supplied to an oil passage 25-2. The oil passage 40-1 is connected to an oil passage 24-la and an oil passage 24-1b. The oil passage 40-2 is diverted and connected to the oil passage 40-1 and the oil passage 40-4. The check valve 40-3 is provided in the oil passage 40-2. The oil passage 40-4 is connected to an oil passage 25-1 and the oil passage 25-2.

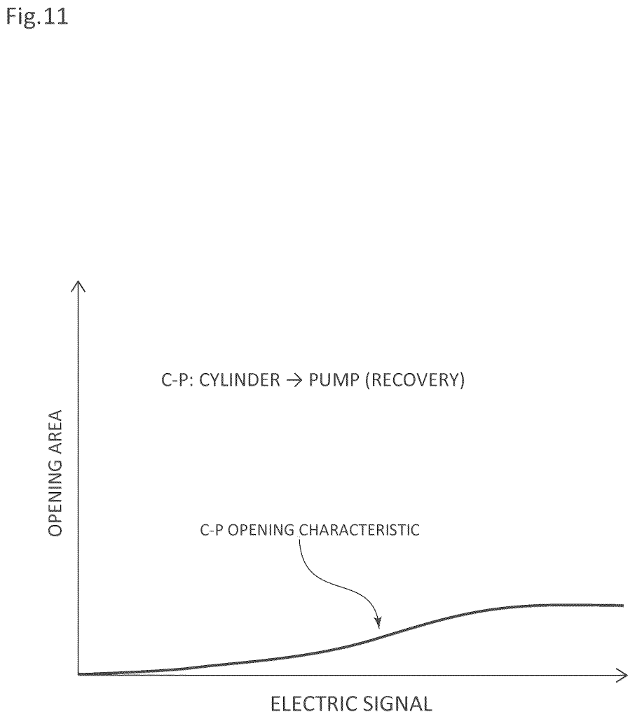

The recovery valve 40 is configured such that a spool strokes substantially in proportion to an electric signal from the controller 14, and as illustrated in FIG. 11, has an opening characteristic in which the opening amount thereof increases according to the spool stroke.

Incidentally, at the neutral position of the recovery valve 40, the recovery valve 40 connects the oil passage 24-la and the oil passage 24-1b, and connects the oil passage 25-1 and the oil passage 25-2. Meanwhile, the recovery passage is omitted.

When the operation lever 12a of the remote control valve 12 is operated in the retraction direction B, similarly to the flow diverter valve 91, an electric signal is input to the recovery valve 40 according to an electric signal to the controller 14 or an electricity storage status of the electricity storage device (not illustrated).

Since the check valve 40-3 is opened according to the differential pressure AP between the fluid pressure Pr of the return oil on the oil passage 40-1 side with respect to the check valve 40-3 of the recovery valve 40 and the fluid pressure Pf of the outgoing oil on the oil passage 40-4 side with respect to the check valve 40-3, as indicated by white arrows in FIG. 13, the return oil can be reused as outgoing oil. Here, the oil passage 40-2 and the check valve 40-3 are a recovery passage R2 in the present embodiment. In such a manner, the recovery passage may be provided at a location other than the switching valve.

### Third Embodiment

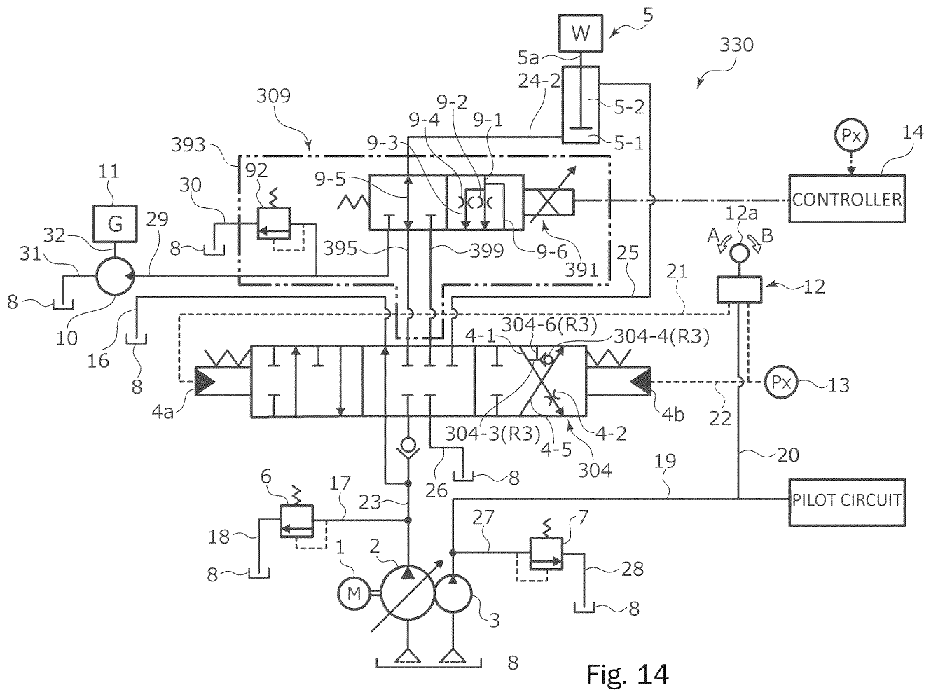

Next, a fluid pressure circuit according to a third embodiment of the present invention will be described with reference to FIGS. 14 to 20. Incidentally, the description of configurations that are the same as and overlap with the configurations of the first and second embodiments will be omitted.

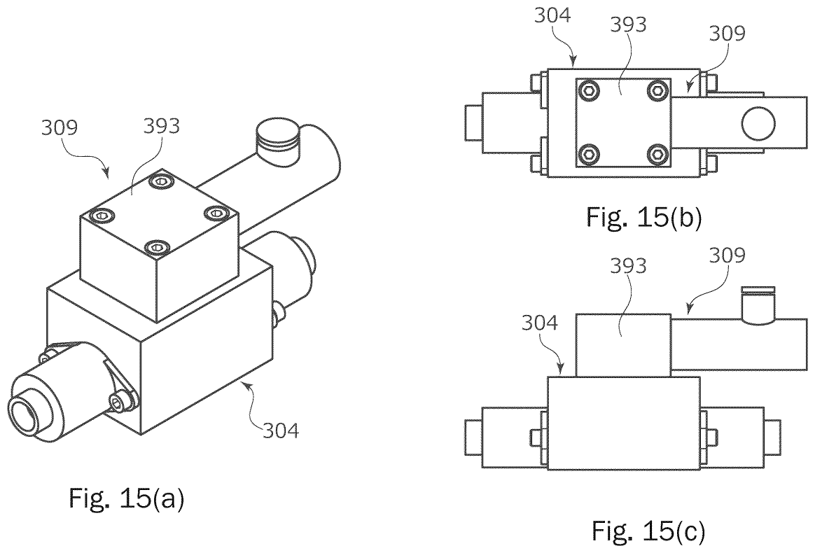

As illustrated in FIGS. 14 and 15, a hydraulic circuit 330 in the third embodiment includes a flow diverter valve device 309 (refer to FIG. 14) that is 4-port, 2-position normally open electromagnetic proportional throttle valve on a switching valve 304 (refer to FIG. 14) that is a 3-position, 7-port open center switching valve. In addition, a housing of the switching valve 304 and a housing 393 of the flow diverter valve device 309 are fixed in contact with each other using four bolts (refer to FIG. 15). In the first embodiment as well, a housing of the switching valve 4 and the housing 93 of the flow diverter valve device 9 may be fixed in contact with each other. The same also applies to the second embodiment.

As illustrated in FIG. 14, the switching valve 304 mainly includes the oil passage 4-1, the throttle 4-2, an oil passage 304-3, a check valve 304-4, the oil passage 4-5, and an oil passage 304-6 on a retraction position side. The oil passage 304-3 is diverted and connected to the oil passage 4-1 on the hydraulic cylinder 5 side with respect to the throttle 4-2, and is diverted and connected to the oil passage 304-6. The check valve 304-4 is provided in the oil passage 304-6. The oil passage 304-6 is diverted and connected to the oil passage 4-5, and is connected to an oil passage 399 of the flow diverter valve device 309 (refer to FIG. 17).

The flow diverter valve device 309 mainly includes a flow diverter valve 391; the relief valve 92; and the housing 393 that accommodates the flow diverter valve 391 and the relief valve 92.

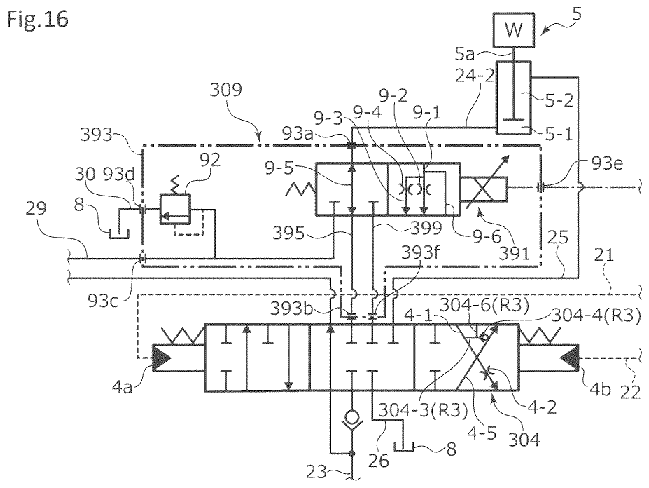

As illustrated in FIGS. 16 and 17, the housing 393 is provided with ports 93a, 93c, 93d, 393b, and 393f, the opening 93e, and oil passages 94, 96 to 98, 395, and 399.

The port 393b is directly coupled to a port of the switching valve 304 to which the oil passage 4-1 is switched and connected. The port 393f is directly coupled to a port of the switching valve 304 to which the oil passage 304-6 is switched and connected.

The oil passage 395 connects the flow diverter valve 391 and the port 393b. The oil passage 399 connects the flow diverter valve 391 and the port 393f.

The flow diverter valve 391 includes the oil passage 9-1, the throttle 9-2, the oil passage 9-3, the throttle 9-4, the oil passage 9-5, and an oil passage 9-6. The throttle 9-2 is provided in the oil passage 9-1 on the switching valve 4 side with respect to the location where the oil passage 9-3 is diverted and connected to the oil passage 9-1. The oil passage 9-3 is diverted and connected to the oil passage 9-1, and is connected to the oil passage 29. The throttle 9-4 is provided in the oil passage 9-3. The oil passage 9-6 is diverted and connected to the oil passage 9-1, and is connected to the oil passage 399 (refer to FIG. 17). In addition, the oil passage 9-6 is a passage with a lower fluid resistance than the oil passage 9-3, and differs from the oil passages 9-1 and 9-3 in that no throttle is provided in the oil passage 9-6.

Accordingly, in a state where the flow diverter valve 391 is at the regeneration position, some of the return oil that has flowed into the flow diverter valve 391 from the oil passage 24-2 is guided to the oil passages 9-6 and 399 with priority rather than passing through the throttle 9-2, passing through the oil passage 4-1 of the switching valve 304 or the throttle 9-4, and flowing into the oil passage 29. Here, the oil passages 9-6 and 399 are passages with low fluid resistance in the present embodiment.

When the fluid pressure Pr of the return oil that has flowed into the oil passage 304-6 of the switching valve 304 from the oil passage 9-6 is higher than the fluid pressure Pf of the outgoing oil that has flowed into the oil passage 4-5, the check valve 304-4 is opened. Accordingly, as indicated by white arrows in FIG. 17, the return oil flows into the oil passage 4-5, and is supplied to the rod chamber 5-2 of the hydraulic cylinder 5.

In addition, some of the return oil that has flowed into the flow diverter valve 391, has passed through the throttle 9-2, and has flowed into the oil passage 4-1 of the switching valve 304 flows into the oil passage 304-6 via the oil passage 304-3 (incidentally, since the flow rate is small, no white arrow is attached in FIG. 17), and when the check valve 304-4 is opened, the some of the return oil flows into the oil passage 4-5, and is supplied to the rod chamber 5-2 of the hydraulic cylinder 5. Here, the oil passage 304-3, the check valve 304-4, and the oil passage 304-6 are a recovery passage R3 in the present embodiment.

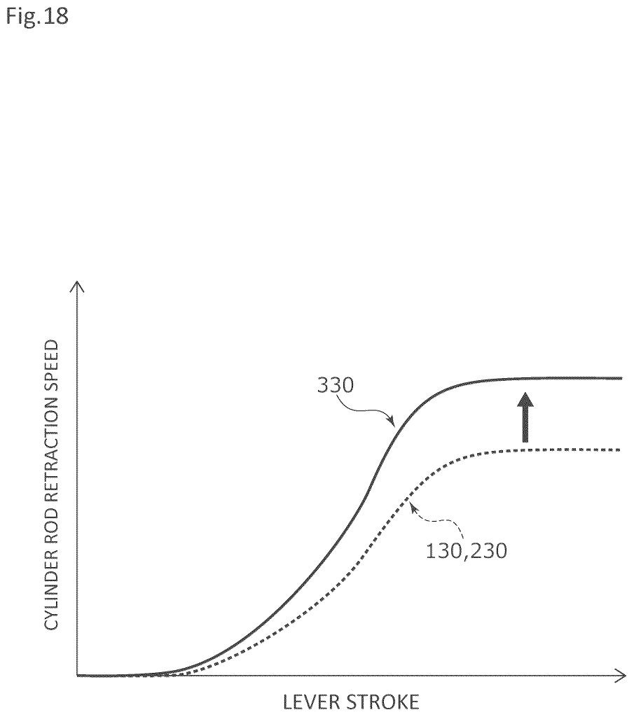

Accordingly, the hydraulic circuit 330 in the present embodiment indicated by a solid line in the graph of FIG. 18 can increase the operation speed of the hydraulic cylinder 5 compared to the hydraulic circuits 130 and 230 in the first and second embodiments indicated by a dotted line. In other words, the operation speed of the hydraulic cylinder 5 can be prevented from decreasing compared to a case where the flow diverter valve device is at a non-flow diversion position.

In addition, in the hydraulic circuit 330 of the present embodiment, since the pressure oil is recovered through the oil passage 9-6 with low fluid resistance, the return oil discharged from the hydraulic cylinder 5 can be used for recovery with priority compared to the hydraulic circuits 130 and 230 in the first and second embodiments, so that the recovery efficiency is increased.

In addition, since the flow diverter valve device 309 is integrally assembled with the switching valve 304, flow passage resistance acting on the return fluid when passing through the flow diverter valve device 309 and the switching valve 304 can be reduced. Further, oil passages connected to the switching valve 304 and the flow diverter valve device 309 when the switching valve 304 and the flow diverter valve device 309 are assembled into the hydraulic circuit 330 may be only the oil passages 23, 24-2, 25, and 29, so that workability is good.

In addition, since the oil passage 9-6 that is a passage with low fluid resistance is provided in the flow diverter valve 391, the fluid pressure circuit can be simply configured, for example, compared to a configuration in which another passage diverted and connected to the passage communicating with the flow diverter valve is a passage with low fluid resistance.

Incidentally, the configuration in which the flow diverter valve device 309 is fixed to the switching valve 304 using four bolts has been described; however, the present invention is not limited thereto, and the number of bolts may be changed as appropriate, and for example, fixing may be performed using fixing means other than bolts, such as welding or adhesion. In addition, the switching valve and the flow diverter valve device may be integrally configured.

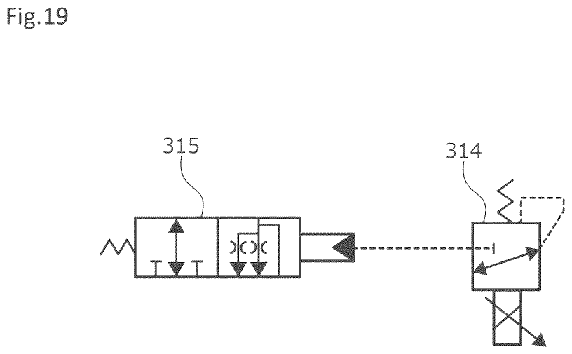

In addition, the flow diverter valve 391 in the present embodiment is an electromagnetic proportional control valve, but is not limited thereto, and for example, as illustrated in FIG. 19, may be a pilot-actuated valve 315 that is actuated by external signal pressure from an electromagnetic proportional valve 314. This also applies to the first and second embodiments.

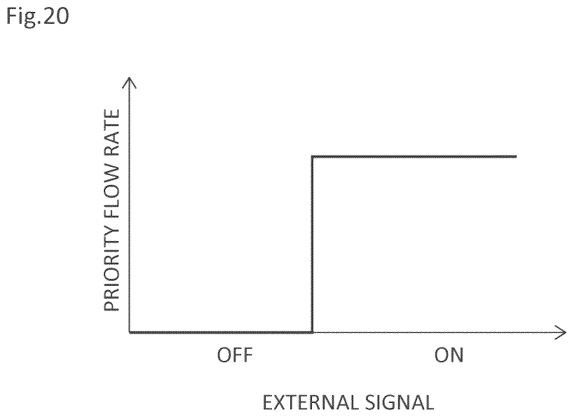

In addition, the flow diverter valve 391 in the present embodiment is a pressure-compensated electromagnetic proportional control type flow rate adjustment valve, but is not limited thereto, and for example, as illustrated in FIG. 20, may be an ON-OFF type valve, and the flow rate when the valve is ON may be constant. This also applies to the first and second embodiments.

In addition, the switching valve 304 in the present embodiment has been described as including the oil passage 304-3; however, the present invention is not limited thereto, and the oil passage 304-3 may be omitted.

### Fourth Embodiment

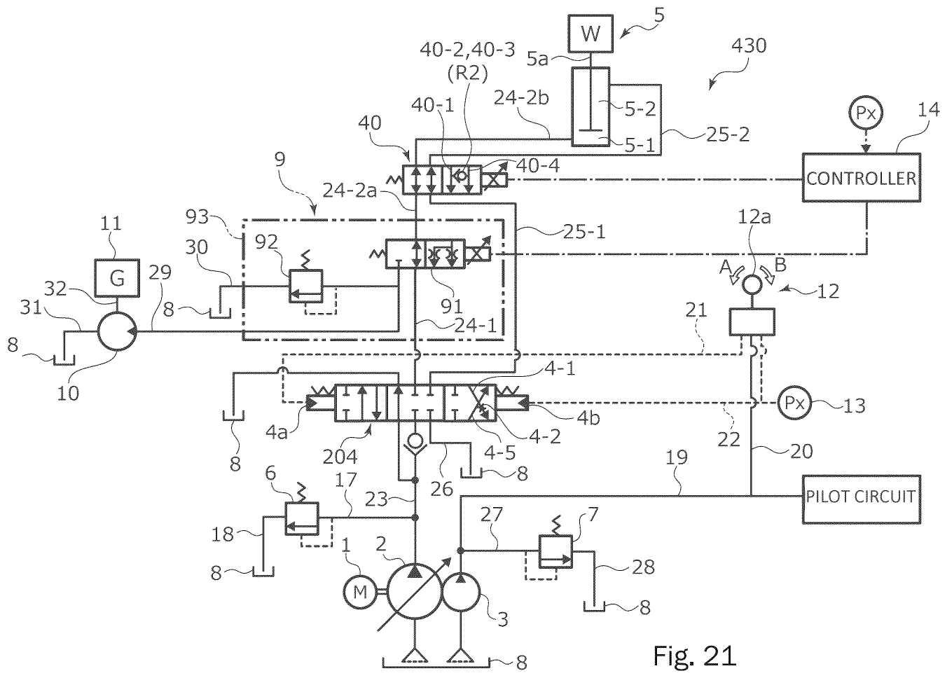

Next, a fluid pressure circuit according to a fourth embodiment will be described with reference to FIG. 21. Incidentally, the description of configurations that are the same as and overlap with the configurations of the first to third embodiments will be omitted.

As illustrated in FIG. 21, a hydraulic circuit 430 in the fourth embodiment differs from that in the second embodiment in that the recovery valve 40 is provided between the hydraulic cylinder 5 and the flow diverter valve device 9, and has substantially the same configuration in other respects.

The recovery valve 40 is connected to an oil passage 24-2a and an oil passage 24-2b between the hydraulic cylinder 5 and the flow diverter valve device 9, and is connected to the oil passage 25-1 and the oil passage 25-2 between the switching valve 204 and the hydraulic cylinder 5.

Accordingly, the oil passage 40-1 of the recovery valve 40 is disposed closer to the hydraulic cylinder 5 side than the oil passages 9-1 and 9-3 of the flow diverter valve 91, while the throttles are omitted, so that some of the return oil can be guided to the oil passage 40-2 with priority. Here, the oil passage 40-1 is a passage with low fluid resistance in the present embodiment. For that reason, similarly to the third embodiment, the operation speed of the hydraulic cylinder 5 can be prevented from decreasing. In such a manner, the passage with low fluid resistance may be provided outside the flow diverter valve.

The embodiments of the present invention have been described above with reference to the drawings; however, the specific configurations are not limited to the embodiments, and changes or additions that are made without departing from the scope of the present invention are included in the present invention.

For example, in the first to fourth embodiments, the configuration in which the valve of the present invention is a flow diverter valve has been described; however, the present invention is not limited thereto, and the valve may not have a flow diversion function as long as the valve includes a throttle. With such a configuration, for example, another passage diverted and connected to the passage communicating with the valve may be connectable to the recovery passage. In such a configuration, in the middle of the other passage connectable to the recovery passage, a throttle may be provided or a throttle may be not provided.

In addition, in the first to fourth embodiments, the flow diverter valve has been described as diverting the fluid to one recovery passage side and one regenerative mechanism side; however, the present invention is not limited thereto, and the configuration may be such that the number of at least one of the recovery passages and the regenerative mechanisms is plural and the fluid is diverted to each.

In addition, in the first and fourth embodiments, the mode in which the switching valve is actuated by pilot pressure and the flow diverter valve is actuated by electricity has been provided as an example; however, for example, both the control valve and the flow diverter valve may be actuated by the same pilot pressure, electricity, or the like.

In addition, in the first to fourth embodiments, oil has been described as an example of the fluid of the fluid pressure circuit; however, it goes without saying that the present invention can be applied to all fluids such as water or air. Further, the fluid supply source that pressurizes the fluid in the tank is not limited to the hydraulic pump, and can be changed to various types depending on the fluid used in the fluid pressure circuit, and for example, may be an air cylinder, an accumulator, or the like.

In addition, in the first to fourth embodiments, the configuration in which the regenerative motor is connected to the flow diverter valve via the oil passage has been described; however, the present invention is not limited thereto, and a pressure boosting device that boosts the pressure of the fluid and an accumulator that accumulates the fluid may be provided, or another cylinder device may be provided, and the configuration connected to the flow diverter valve may be changed as appropriate.

### REFERENCE SIGNS LIST

1 Drive mechanism
2 Main hydraulic pump
3 Pilot hydraulic pump
4 Switching valve
4-3 Oil passage (part of recovery passage)
4-4 Check valve (part of recovery passage)
5 Hydraulic cylinder (cylinder device)
5-1 Bottom chamber (first or second chamber)
5-2 Rod chamber (second or first chamber)
8 Tank
9-1 Oil passage (throttle passage)
9-2 Throttle
9-3 Oil passage (throttle passage)
9-4 Throttle
10 Regenerative motor
11 Generator
91 Flow diverter valve (valve)
130 Hydraulic circuit
40 Recovery valve
40-2 Oil passage (part of recovery passage)
40-3 Check valve (part of recovery passage)
204 Switching valve
230 Hydraulic circuit
304 Switching valve
304-3 Oil passage (part of recovery passage)
304-4 Check valve (part of recovery passage)
304-6 Oil passage (part of recovery passage)
9-6 Oil passage (part of low-fluid-resistance passage)
391 Flow diverter valve (valve)
315 Pilot-actuated valve (valve)
330 Hydraulic circuit
399 Oil passage (part of low-fluid-resistance passage)
40-1 Oil passage (low-fluid-resistance passage)
430 Hydraulic circuit
R1 to R3 Recovery passages

1: A fluid pressure circuit, comprising:
a fluid supply source;
a cylinder device including a first chamber and a second chamber which are partitioned from each other;
a valve that is configured to divert some of a return fluid from the cylinder device to discharge the return fluid via a throttle; and
a recovery passage which is provided between the fluid supply source and the cylinder device and through which the return fluid flows from the first chamber to the second chamber.

2: The fluid pressure circuit according to claim 1,
wherein the fluid pressure circuit further includes a throttle passage provided with the throttle in the valve, and a low-fluid-resistance passage with a lower fluid resistance than the throttle passage, wherein the low-fluid-resistance passage is configured for communicating with the recovery passage.

3: The fluid pressure circuit according to claim 2,
wherein the low-fluid-resistance passage is provided in the valve.

4: The fluid pressure circuit according to claim 2,
wherein the throttle passage includes two passage parts, wherein one of the two passage parts is configured for communicating with the recovery passage.

5: The fluid pressure circuit according to claim 1, further comprising
a switching valve provided in a flow passage between the fluid supply source and the valve to control an inflow and outflow of a fluid between the fluid supply source and the cylinder device, and
the recovery passage is provided inside the switching valve.

6: The fluid pressure circuit according to claim 1,
wherein the recovery passage is configured to allow for a flow therein only when the cylinder device is retracted.

7: The fluid pressure circuit according to claim 2,
wherein the recovery passage is configured to allow for a flow therein only when the cylinder device is retracted.

8: The fluid pressure circuit according to claim 3,
wherein the recovery passage is configured to allow for a flow therein only when the cylinder device is retracted.

9: The fluid pressure circuit according to claim 4,
wherein the recovery passage is configured to allow for a flow therein only when the cylinder device is retracted.

10: The fluid pressure circuit according to claim 5,
wherein the recovery passage is configured to allow for a flow therein only when the cylinder device is retracted.
